(19) United States
(12) Patent Application Publication
(10) Pub. No.: US 2024/0394962 A1
(43) Pub. Date: Nov. 28, 2024

(54) VIRTUAL REPRESENTATION EMOVECTORS

(71) Applicant: International Business Machines Corporation, Armonk, NY (US)

(72) Inventors: Raymund Lin, Taipei (TW); Sherwin Jaleel, Southampton (GB); Chih-Wen Su, Shihlin (TW); Ying-Chen Yu, Taipei (TW); Jeff Hsueh-Chang Kuo, Taipei (TW)

(21) Appl. No.: 18/321,100

(22) Filed: May 22, 2023

(51) Int. Cl. G06T 17/00; G06F 40/56; G06T 13/20; G06T 13/40; G06V 10/28; G06V 40/16; G06V 40/20

(52) U.S. Cl. CPC G06T 17/00; G06F 40/56; G06T 13/205; G06T 13/40; G06V 10/28; G06V 40/174; G06V 40/23

(57) ABSTRACT

Techniques are provided for implanting emovectors with virtual representatives. In one embodiment, the techniques involve generating a virtual representative based on visual data of a first user, generating an emovector of a second user of a virtual environment, generating an input of a machine learning model based on the emovector of the second user, and controlling the virtual representative based on an output of the machine learning model.

### BACKGROUND

The present disclosure relates to virtual environments, and more specifically, to user representations and interactions in virtual environments.

In traditional virtual reality systems, a user can create a virtual reality representative known as an avatar. The avatar is a graphical representation that can be paired with a chatbot and a text-to-speech system to enable audio feedback of the avatar. However, the avatar cannot reproduce the emotional expressions, the facial expressions, or the body movements of the user.

### SUMMARY

A method is provided according to one embodiment of the present disclosure. The method includes generating a virtual representative based on visual data of a first user; generating an emovector of a second user of a virtual environment; generating an input of a machine learning model based on the emovector of the second user; and controlling the virtual representative based on an output of the machine learning model.

A system is provided according to one embodiment of the present disclosure. The system includes a processor; and memory or storage comprising an algorithm or computer instructions, which when executed by the processor, performs an operation that includes: generating a virtual representative based on visual data of a first user; generating an emovector of a second user of a virtual environment; generating an input of a machine learning model based on the emovector of the second user; and controlling the virtual representative based on an output of the machine learning model.

A computer-readable storage medium having computer-readable program code embodied therewith, the computer-readable program code executable by one or more computer processors to perform an operation, is provided according to one embodiment of the present disclosure. The operation includes generating a virtual representative based on visual data of a first user; generating an emovector of a second user of a virtual environment; generating an input of a machine learning model based on the emovector of the second user; and controlling the virtual representative based on an output of the machine learning model.

### BRIEF DESCRIPTION OF THE DRAWINGS

FIG. 1 illustrates a computing environment, according to one embodiment.

FIG. 2 illustrates a virtual representation environment, according to one embodiment.

FIG. 3 illustrates a flowchart of a method of generating an emovector, according to one embodiment.

FIG. 4 illustrates a flowchart of a method of generating and controlling a virtual representative, according to one embodiment.

### DETAILED DESCRIPTION

Embodiments of the present disclosure improve upon virtual systems by enabling an automated virtual representative to reproduce user features such as the voice, the facial expressions, and the body movements of a represented user. In one embodiment, a virtual representation module includes an emovector module that uses a user feature capture system to generate emovectors, which represent emotions embedded in human speech and behavior. The virtual representation module can also include a machine learning algorithm that uses a model trained to learn emotional expressions of a user via the emovectors. The machine learning algorithm can then communicate, via the virtual representative, using the learned emotions.

One benefit of the disclosed embodiments is to provide automated virtual representatives that authentically represent the emotional expressions of users, which allows for improved interactions with virtual representatives in virtual environments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

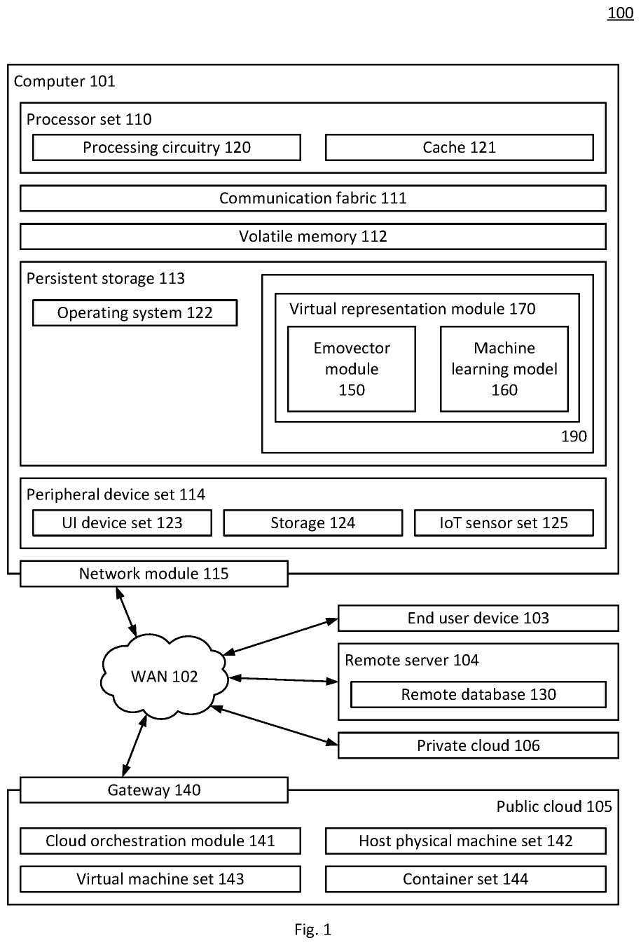

FIG. 1 illustrates a computing environment 100, according to one embodiment. Computing environment 100 contains an example of an environment for the execution of at least some of the computer code involved in performing the inventive methods, such as a new virtual representation module 170, which includes an emovector module 150 and a machine learning algorithm 160, shown in block 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

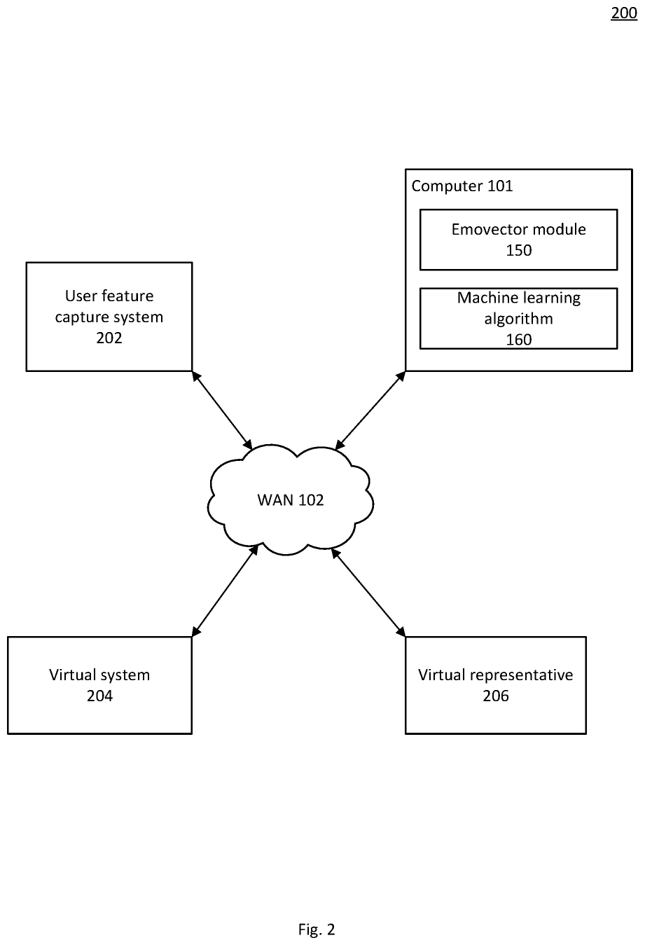

FIG. 2 illustrates virtual representation environment 200, according to one embodiment. In the illustrated embodiment, the virtual representation environment 200 includes a user feature capture system 202, a virtual system 204, a computer 101, and a virtual representative 206, communicatively coupled to a WAN 102.

The user feature capture system 202 can include microphones, cameras, and other sensors to capture audio and visual data of a user while the user is speaking. For instance, the user feature capture system 202 can capture user features such as a voice, a facial expression, or a body movement of the user. The user feature capture system 202 can be integrated into, or separate from, the virtual system 204.

In one embodiment, the virtual system 204 represents a virtual reality headset or an augmented reality headset. The virtual system 204 may include a processor, a memory or storage, and a display. The processor generally obtains instructions and data from the memory or storage. The virtual system 204 is generally under the control of an operating system (OS) suitable to perform or support the functions or processes disclosed herein. The processor is a programmable logic device that performs instruction, logic, and mathematical processing, and may be representative of one or more CPUs. The processor may execute one or more algorithms, instruction sets, or applications in the memory or storage to perform the functions or processes described herein.

In one embodiment, the virtual system 204 shows a virtual environment via the display. The virtual environment can include a virtual reality world, or an augmented reality overlay of the real world, that shows a virtual representative 206.

The virtual representative 206 may represent a digital twin, or another representation, of the user in a virtual environment. In one embodiment, a digital twin is a virtual representation that shares audio, behavioral, structural, visual, or psychological similarities with the user.

In the illustrated embodiment, the computer 101 includes a virtual representation module 170, which includes an emovector module 150 and a machine learning algorithm 160. In one embodiment, the virtual representation module 170, the emovector module 150, and the machine learning algorithm 160 represent one or more algorithms, instruction sets, software applications, or other computer-readable program code that can be executed by the processor set 110 to perform the functions, operations, or processes described herein.

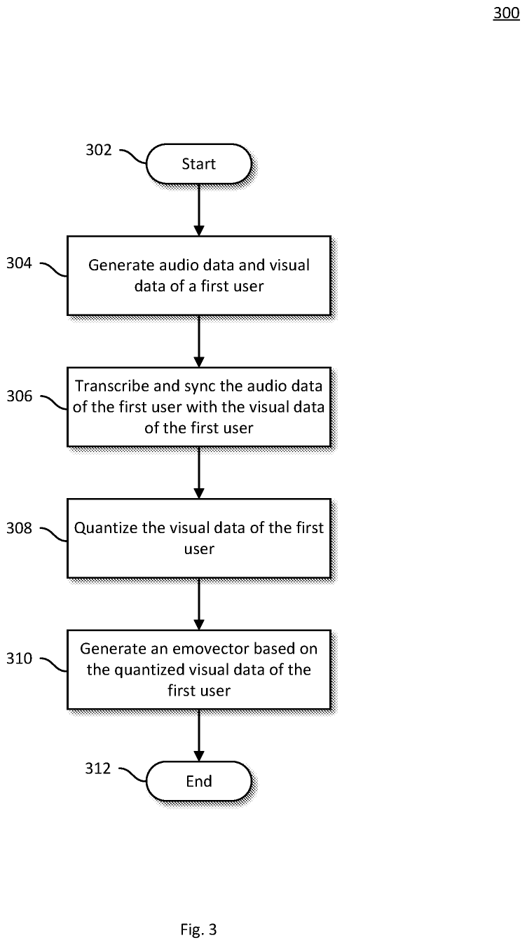

The emovector module 150 can use the audio and visual data from the user feature capture system 202 to generate emovectors that represent emotions embedded in the speech and behavior of the user. This process is described further in FIG. 3 below.

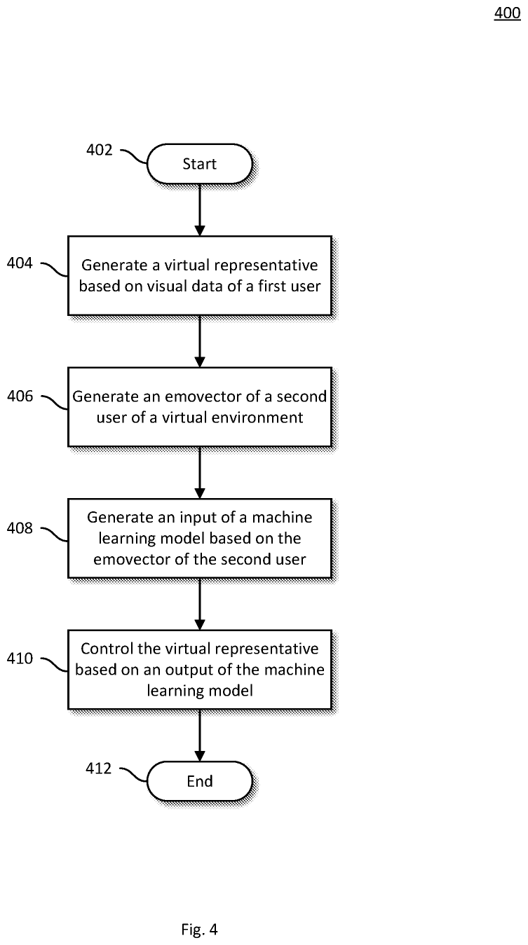

A machine learning model can be trained to learn emotional expressions of the user from the emovectors. The machine learning algorithm 160 can use the model to generate audio and visual outputs that reflect the learned emotional expressions, and use the audio and visual outputs to control the virtual representative 206. This process is described further in FIG. 4 below.

FIG. 3 illustrates a flowchart of a method 300 of generating an emovector, according to one embodiment. The method 300 begins at block 302.

At block 304, the emovector module 150 generates audio data and visual data of a first user. In one embodiment, the audio and visual data include analog signals that represent the voice, facial expressions, and body movements of the first user.

In one embodiment, the emovector module 150 uses the user feature capture system 202 to capture the audio and visual data of the first user while the first user reads a script. For instance, the voice of the first user can be recorded via one or more microphones of the user feature capture system 202. Further, facial expressions of the first user can be determined via cameras and sensors of user feature capture system 202 that track markers placed on the face of the first user, track facial distortions from facial feature designation points projected onto the face of the first user, perform 3D scanning of the face of the first user, perform electromyography sensing on the facial muscles of the first user, or the like. Further, body movements of the first user can be determined via cameras and sensors of the user feature capture system 202 that track the position and orientation of markers attached to the body of the first user.

At block 306, the emovector module 150 transcribes and syncs the audio data with the visual data of the first user. In one embodiment, emovector module 150 transcribes and time-syncs the vocal recording with the captured facial expressions and body movements of the first user, such that each word of the transcript corresponds to vocal data, a facial expression, and a body movement of the first user at the time the word was spoken by the first user.

At block 308, the emovector module 150 quantizes the visual data of the first user. The emovector module 150 can sample and quantize the visual data of the first user to generate a series of discrete data points that represent the facial expressions and body movements of the first user for each word spoken by the first user. In one embodiment, the emovector module 150 can adjust the precision of the visual data based on available storage and processing resources of the computer 101 or the user feature capture system 202. For instance, the emovector module 150 can increase or decrease the sampling rate, and produce a corresponding number of discrete data points of the visual data, when a CPU usage, a GPU usage, a memory usage, or a storage usage does not exceed a predetermined threshold. The quantized visual data of the first user may also be compressed in another process due to storage and processing constraints.

At block 310, the emovector module 150 generates an emovector based on the quantized visual data of the first user. In one embodiment, an emovector represents time-synced facial expression data or body movement data during a timespan of a word spoken by the first user.

For example, an emovector (F1) that represents facial expression data may be expressed as follows:

$$F 1 = [ \begin{matrix}t 1 : & 0.9 & 0.8 & 0.6 & 0.5 \\ t 2 : & 0.8 & 0.7 & 0.7 & 0.4 \\ t 3 : & 0.7 & 0.6 & 0.8 & 0.3\end{matrix} ] ,$$

where t1-13 represent moments in time during the timespan of the word when spoken by the first user, and the numerical values represent quantized facial expression data points that correspond to these moments in time. Another emovector (B1) may represent body movements of the first user for the same word, and the vectors may be expressed as a grouping such as (F1, B1).

In one embodiment, the emovector module 150 filters an emovector by applying a threshold requirement to the facial expression data and the body movement data of the emovector. The filtering process can ensure that the emovector module 150 generates emovectors that represent emotional expressions (as determined by having facial expression data or body movement data that exceeds the threshold), rather than muted or unemotional expressions.

Continuing the above example, the emovector module 150 may determine (using predetermined empirical data) that a facial expression value exceeding 0.5 is required to qualify as an emotional expression. Therefore, since the emovector (F1, B1) includes at least some facial data values that exceed the threshold, the emovector module 150 can output the emovector (F1, B1) instead of filtering out the emovector. The method 300 ends at block 312.

FIG. 4 illustrates a flowchart of a method 400 of generating and controlling a virtual representative, according to one embodiment. The method 400 begins at block 402.

At block 404, a machine learning algorithm 160 generates a virtual representative 206 based on visual data of a first user. In one embodiment, the virtual representative 206 is an audio and visual representation or model of the first user in a virtual environment. The virtual representative 206 may take the form of a digital twin, which shares audio, behavioral, structural, visual, or psychological similarities with the first user.

As discussed above, the emovector module 150 can generate audio and visual data of the first user via the user feature capture system 202. In one embodiment, the machine learning algorithm 160 can use the visual data to create the appearance of the virtual representative 206. An audio component of the virtual representative 206 can be generated as discussed below.

At block 406, the machine learning algorithm 160 generates an emovector of a second user of a virtual environment. In one embodiment, the emovector of the second user represents at least one of: a presence of the second user, an audio or text input of the second user, a facial expression of the second user, a body movement of the second user, an absence of audio or text input of the second user (e.g., a silent moment), an absence of facial expressions of the second user (e.g., a resting facial expression or a blank stare), an absence of body movement of the second user (e.g., standing still), or the like.

For example, the second user can use the virtual system 204 to enter a virtual world (e.g., as an avatar) shared with the virtual representative 206. As previously described, features of the second user can be captured via a user feature capture system 202 that may be integrated with, or separate from, the virtual system 204. When the second user is located near the virtual representative 206 in the virtual world, the second user may verbally greet, physically gesture towards, or remain silent towards the virtual representative 206. In response, the emovector module 150 may process audio and visual data captured by the user feature capture system 202, and generate an emovector that represents the voice, behavior, or silence of the second user.

At block 408, the machine learning algorithm 160 generates an input of a machine learning model based on the emovector of the second user. The input of the machine learning model can include text and emovector words. The text that is input into the machine learning model can be transcribed from audio data of the second user. The emovector word can be created by adding an emovector to a text word, by replacing a text word with an emovector, or by defining an emovector as a new word.

As previously discussed, the emovector module 150 can convert an input from the second user into text and emovectors. For example, when the second user says “Hello. How are you?” to the virtual representative 206, the emovector module 150 can (in real-time) transcribe the statements into text, and can generate emovectors from the text using a process similar to the process described in FIG. 3. The emovector module 150 can also filter the emovectors corresponding to “How” and “are” as emovectors that do not exceed a threshold of emotional expression, such that these emovectors are discarded (but the associated text remains).

The machine learning algorithm 160 can then generate emovector words from the text and emovectors, and input the text and emovector words into the machine learning model. Continuing the above example, the machine learning algorithm 160 can generate emovector words based on the emovectors corresponding to “Hello” and “you”, and can input any combination of the text (“How” and “are”) or emovector words (“Hello” and “you”) into the machine learning model.

In one embodiment, the machine learning algorithm 160 uses a similarity function to identify an emovector that is used to generate the emovector word. When the emovector module 150 generates a first emovector, the machine learning algorithm 160 can perform the similarity function to map the first emovector to an embedded space shared with known emovectors of the machine learning model, and calculate distances between the first emovector and the known emovectors. The machine learning algorithm 160 can then map the first emovector to a second emovector of the known emovectors, where the second emovector has the shortest distance out of the distances between the first emovector and the known emovectors. The second emovector can be used to generate the emovector word that is input into the machine learning model.

For example, if the second user nods, but does not speak, to the virtual representative 206, the emovector module 150 can generate an emovector that captures this user feature. However, the emotional expression represented by the emovector may not be easily determined by the machine learning model. Therefore, in order to determine which emotional expression is associated with this emovector, the machine learning algorithm 160 may map the emovector to a known emovector that is associated with the text word “sad” or “tired”. In this manner, the machine learning algorithm 160 can correctly identify or approximate the emotional expressions of the second user in real-time.

The machine learning model can be a language learning model trained to generate conversational language with a user, where training data for the model includes text and emovector words. In one embodiment, relationships between the text and emovector words are determined via a supervised learning process, where weights for the model are updated using back-propagation techniques to optimize a loss function output by the model. In another embodiment, the statistical regularities between the text and emovector words are determined via an unsupervised learning process. In this manner, given text words or emovector words as inputs, the model can predict probability distributions of text words or emovector words to output. Continuing the example of the second user greeting the virtual representative with “Hello. How are you?”, the machine learning model may output high probability distributions for a combination of text words (e.g., “I'm well”) and emovector words (e.g., “Thanks for asking!”) that responds to the greeting of the second user.

At block 410, the machine learning algorithm 160 controls the virtual representative 206 based on an output of the machine learning model. In one embodiment, controlling the virtual representative 206 involves the virtual representative 206 outputting audio, depicting text, controlling or animating a facial expression, controlling or animating a body movement, or the like, using an output of the machine learning model.

For example, the machine learning algorithm 160 can use a text to speech feature that includes the voice of the first user to vocalize, via the virtual representative 206, the output of the machine learning model. Further, the machine learning algorithm 160 can use emovectors of the emovector words to reproduce, via the virtual representative 206, facial expressions and body movements of the first user that correspond to the words or emovector words when spoken by the virtual representative 206. In this manner, the virtual representation module 170 may represent a text-to-3D system or a text-to-virtual representative system. The method 400 ends at block 412.

While the foregoing is directed to embodiments of the present invention, other and further embodiments of the invention may be devised without departing from the basic scope thereof, and the scope thereof is determined by the claims that follow.

What is claimed is:

1. A method comprising:
generating a virtual representative based on visual data of a first user;
generating an emovector of a second user of a virtual environment;
generating an input of a machine learning model based on the emovector of the second user; and
controlling the virtual representative based on an output of the machine learning model.

2. The method of claim 1, wherein the virtual representative comprises a model or representation of the first user in the virtual environment, wherein the virtual representative shares audio, behavioral, structural, visual, or psychological features with the first user, and wherein the virtual environment includes a virtual reality world or an augmented reality overlay of a real world.

3. The method of claim 1, wherein the emovector of the second user includes time-synced facial expression data or body movement data associated with a timespan of a word spoken by the second user, and wherein the emovector of the second user represents at least one of: a presence of the second user, an audio or text input of the second user, a facial expression of the second user, a body movement of the second user, an absence of audio or text input of the second user, an absence of facial expressions of the second user, or an absence of body movements of the second user.

4. The method of claim 1, wherein generating the emovector of the second user comprises:
generating audio data and visual data of the second user;
transcribing and syncing the audio data with the visual data of the second user;
quantizing the visual data of the second user; and
generating the emovector of the second user based on the quantized visual data of the second user.

5. The method of claim 1, wherein the machine learning model represents a language learning model trained to generate conversational language with the second user, wherein the input of the machine learning model includes an input emovector word comprising an input emovector or a combination of input text and the input emovector, and wherein the output of the machine learning model includes a probability distribution of an output emovector or a combination of output text and the output emovector.

6. The method of claim 1, wherein generating the input of the machine learning model comprises:
mapping a first emovector to an embedded space shared with known emovectors of the machine learning model;
determining distances between the first emovector and the known emovectors;
mapping the first emovector to a second emovector of the known emovectors, wherein the second emovector represents a shortest distance of the distances between the first emovector and the known emovectors; and
generating an emovector word based on the second emovector.

7. The method of claim 1, wherein controlling the virtual representative involves outputting at least one of: an audio or text output of the virtual representative, a facial expression of the virtual representative, or a body movement of the virtual representative.

8. A system, comprising:
a processor; and
memory or storage comprising an algorithm or computer instructions, which when executed by the processor, performs an operation comprising:
generate a virtual representative based on visual data of a first user;
generate an emovector of a second user of a virtual environment;
generate an input of a machine learning model based on the emovector of the second user; and
control the virtual representative based on an output of the machine learning model.

9. The system of claim 8, wherein the virtual representative comprises a model or representation of the first user in the virtual environment, wherein the virtual representative shares audio, behavioral, structural, visual, or psychological features with the first user, and wherein the virtual environment includes a virtual reality world or an augmented reality overlay of a real world.

10. The system of claim 8, wherein the emovector of the second user includes time-synced facial expression data or body movement data associated with a timespan of a word spoken by the second user, and wherein the emovector of the second user represents at least one of: a presence of the second user, an audio or text input of the second user, a facial expression of the second user, a body movement of the second user, an absence of audio or text input of the second user, an absence of facial expressions of the second user, or an absence of body movements of the second user.

11. The system of claim 8, wherein generating the emovector of the second user comprises:
generating audio data and visual data of the second user;
transcribing and syncing the audio data with the visual data of the second user;
quantizing the visual data of the second user; and
generating the emovector of the second user based on the quantized visual data of the second user.

12. The system of claim 8, wherein the machine learning model represents a language learning model trained to generate conversational language with the second user, wherein the input of the machine learning model includes an input emovector word comprising an input emovector or a combination of input text and the input emovector, and wherein the output of the machine learning model includes a probability distribution of an output emovector or a combination of output text and the output emovector.

13. The system of claim 8, wherein generating the input of the machine learning model comprises:
mapping a first emovector to an embedded space shared with known emovectors of the machine learning model;
determining distances between the first emovector and the known emovectors;
mapping the first emovector to a second emovector of the known emovectors, wherein the second emovector represents a shortest distance of the distances between the first emovector and the known emovectors; and
generating an emovector word based on the second emovector.

14. The system of claim 8, wherein controlling the virtual representative involves outputting at least one of: an audio or text output of the virtual representative, a facial expression of the virtual representative, or a body movement of the virtual representative.

15. A computer-readable storage medium having a computer-readable program code embodied therewith, the computer-readable program code executable by one or more computer processors to perform an operation comprising:
generating a virtual representative based on visual data of a first user;
generating an emovector of a second user of a virtual environment;
generating an input of a machine learning model based on the emovector of the second user; and
controlling the virtual representative based on an output of the machine learning model.

16. The computer-readable storage medium of claim 15, wherein the virtual representative comprises a model or representation of the first user in the virtual environment, wherein the virtual representative shares audio, behavioral, structural, visual, or psychological features with the first user, and wherein the virtual environment includes a virtual reality world or an augmented reality overlay of a real world.

17. The computer-readable storage medium of claim 15, wherein the emovector of the second user includes time-synced facial expression data or body movement data associated with a timespan of a word spoken by the second user, and wherein the emovector of the second user represents at least one of: a presence of the second user, an audio or text input of the second user, a facial expression of the second user, a body movement of the second user, an absence of audio or text input of the second user, an absence of facial expressions of the second user, or an absence of body movements of the second user.

18. The computer-readable storage medium of claim 15, wherein generating the emovector of the second user comprises:
generating audio data and visual data of the second user;
transcribing and syncing the audio data with the visual data of the second user;
quantizing the visual data of the second user; and
generating the emovector of the second user based on the quantized visual data of the second user.

19. The computer-readable storage medium of claim 15, wherein generating the input of the machine learning model comprises:
mapping a first emovector to an embedded space shared with known emovectors of the machine learning model;
determining distances between the first emovector and the known emovectors;
mapping the first emovector to a second emovector of the known emovectors, wherein the second emovector represents a shortest distance of the distances between the first emovector and the known emovectors; and
generating an emovector word based on the second emovector.

20. The computer-readable storage medium of claim 15, wherein controlling the virtual representative involves outputting at least one of: an audio or text output of the virtual representative, a facial expression of the virtual representative, or a body movement of the virtual representative.
